(19) United States
(12) Patent Application Publication
(10) Pub. No.: US 2018/0102730 A1
(43) Pub. Date: Apr. 12, 2018

(54) Intelligent Solar Roadway System and Solar Roadway Panels

(71) Applicant: Solar Roadways Incorporated, Sagle, ID (US)

(72) Inventors: Scott David Brusaw, Sagle, ID (US); Julie Ann Brusaw, Sagle, ID (US)

(73) Assignee: Solar Roadways Incorporated, Sagle, ID (US)

(21) Appl. No.: 15/840,123

(22) Filed: Dec. 13, 2017

Related U.S. Application Data
(63) Continuation-in-part of application No. 14/531,298, filed on Nov. 3, 2014.

(51) Int. Cl. H02S 20/21; G08G 1/005; G08G 1/08; G08G 1/052; G08G 1/056; G08G 1/01; E01C 1/00; E01C 17/00; E01C 11/26; G08G 1/123

(52) U.S. Cl. CPC H02S 20/21; G08G 1/005; G08G 1/08; G08G 1/052; G08G 1/056; H02S 40/32; E01C 1/007; E01C 17/00; E01C 1/002; E01C 11/26; G08G 1/123; G08G 1/0145

(57) ABSTRACT

An intelligent roadway system of trafficable solar roadway panels for collecting solar energy, converting the solar energy into electricity, illuminating LEDs, storing and distributing the electrical energy and sensing dynamic conditions on and about the trafficable solar roadway panels and communicating the sensed dynamic conditions and precise global positioning system (GPS) location of the sensed dynamic conditions to a user for use.

### RELATED APPLICATIONS

This utility patent application is a Continuation In Part (CIP) of co-pending U.S. Utility patent application Ser. No. 14/531,298 titled Improved Method and System for Collecting, Storing and Distributing Solar Energy using Networked Trafficable Solar Panels which was filed on Nov. 3, 2014; which is a Continuing application of U.S. application Ser. No. 12/800,060, now U.S. Pat. No. 8,907,202 titled Method and System for Collecting, Storing and Distributing Solar Energy Using Networked Trafficable Solar Panels which was filed on May 7, 2010.

Pursuant to 35 USC § 120 and 37 CFR § 1.78, this CIP utility patent application has codependency with earlier filed U.S. patent application Ser. No. 14/531,298 for which this CIP utility patent application claims its priority benefit; and further this CIP utility patent application shares at least one joint inventor with earlier filed U.S. patent application Ser. No. 14/531,298 from which this CIP utility patent application claims its priority benefit.

### BACKGROUND OF INVENTION

### Field of Invention

This invention relates to an intelligent roadway system of trafficable solar roadway panels for collecting solar energy, converting the solar energy into electricity, illuminating LEDs, storing and distributing the electrical energy and sensing dynamic conditions on and about the trafficable solar roadway panels and communicating the sensed dynamic conditions and precise global positioning system (GPS) location of the sensed dynamic conditions to a user for use.

### Background and Description of Prior Art

It is well-known that electricity may be derived from photovoltaic systems made of solar panels that collect solar energy. A plurality of solar panels is generally referred to as a solar “array” which, by definition is larger than a solar panel, and correspondingly has an ability to collect more solar energy and generate more electricity.

Solar energy is generally harnessed using one of two methods. In a first method solar energy is collected using photovoltaic cells that employ semi-conductor materials that translate photon energy from sunlight to direct current (DC) electrical energy. In the second method, thermal solar energy is collected using dark colored surfaces to collect heat from sunlight. Thereafter, the heat energy is transferred via liquids, to a location where it can be used. The instant invention described herein relates to the first method.

A typical solar energy cell, also known as a photovoltaic photoreceptor, is solid state device in which a junction is formed between adjacent layers of semi-conductor materials, typically silicone. When photons strike the semi-conductor material, electrons are dislodged. The dislodged electrons, which are collected by an electric field at the junction, create a voltage that can be put to work in an external circuit. The basic scientific principals that underlie electricity generation using solar cells are well-known and understood to those skilled in the art.

Solar power generation is one method of generating clean energy. However, despite the fact the cost of solar power generation has decreased, and the efficiency of such systems has improved, there remains a lack of a cohesive integrated infrastructure that uses solar energy as a power source.

Instead, solar energy is typically employed in small scale isolated instances. This lack of a cohesive infrastructure is one contributing factor to the fact that presently, solar power is estimated to generate less than approximately five percent (5%) of the electricity consumed in the United States.

There are also drawbacks associated with solar panels and solar arrays that are found mostly in roof based or remote installations. Known solar panels and solar arrays are easily damaged by impacts and are not suited for supporting loads directly thereon. Because solar panels are so easily damaged, known solar panels and known solar arrays have been limited to installation in locations that are not traffic bearing and also in geographic locations that are unlikely to experience extreme weather, such as tornadoes, hurricanes, typhoon's and hailstorms. As a result, known solar panels and known solar arrays are typically only used in limited geographic areas and, within the those limited geographic areas, only in physical locations that are not traffic bearing (i.e. people do not walk upon and vehicles do not traverse).

Individually mounted solar panels on roofs are expensive. More fundamentally, however, individual solar energy systems for individual residences and structures, as well as installing the associated infrastructure, is inefficient and costly. Many areas which have high electricity demand and consumption have limited roof space and have limited unused ground space where solar arrays may be installed. Thus, the limited available space for placement of panels generally would not generate sufficient electricity to make such a system economically viable.

Further, some residential, commercial, community and governmental customers find the appearance of solar panels on roofs unappealing and unattractive. In some localities, local regulations and covenants may prohibit installation of solar panels. Further still, known solar panels are easily damaged by objects such as by hailstones and flying debris and as a result are not well suited for geographic areas that experience violent stormy weather. The drawback of being so easily damaged is exacerbated even further by the difficulty of securely mounting solar panels to a movable supportive structure since most solar panels need to “track” or “follow” the arc of the Sun as the earth rotates to maximize efficiency and electricity generation. Such moving mounting systems are typically not as strong or as stable as a fixed mounting, and such movable mounting systems are also subject to damage by violent storms, and also by normal wear and tear which requires periodic maintenance.

Previously, placing photovoltaic cells under a strong transparent covering/panel capable of supporting persons and/or vehicles has been purposefully and actively avoided because the transparent panel reduced the photovoltaic cell's operational efficiency to a level where the photovoltaic cell was essentially inoperative. Any redirection in the operational efficiency of the photovoltaic cell was material because of the limited surface area over which the solar panels and solar arrays were installed. Therefore, because the available surface area for installation was so limited, maximum efficiency of every photovoltaic cell within a solar panel had to be maintained. Nearly any reduction in efficiency, including a reduction caused by placing the photovoltaic cells under a transparent panel or other weight bearing covering was a material detriment that needed to be avoided.

Even further still, solar panels have heretofor been designed, manufactured, installed and used primarily solely for the collection of solar energy and resulting generation of electricity. This singular use of such panels is inefficient and costly. Our invention provides durable multi-use solar panels which are well suited for uses in addition to collecting solar energy and generating electricity and also provides a ready solution to a variety of unmet needs.

What is needed is a strong traffic bearing capable solar panel that can be fixedly installed in geographic and physical locations not heretofore suitable for solar panels and solar arrays and also for purposes in addition to collection of solar energy.

Our invention resolves various of the aforementioned disadvantages of known solar panels and solar arrays, and provides a fixedly mounted modular traffic bearing system for the efficient collection of solar energy, transformation of solar energy into electrical energy and distribution thereof while simultaneously providing benefits and functions and uses not heretofore possible with of known solar panels and known solar arrays.

Our invention is a plurality of interconnected solar panels forming a solar array that provides a trafficable supportive surface with an incorporated system that collects solar energy, generates electric energy for distribution to homes, businesses, and the electrical grid and provides lighting, ice and snow accumulation prevention, data collection and data transmission for public safety, communication, transportation, navigation and the like. In short, current trafficable surfaces including but not limited to roadways, parking lots, driveways, rooftops, sidewalks, bike paths and other trafficable areas are replaced by, or covered with solar panels that support traffic thereover and thereon while simultaneously generating electricity and lighting for useful purposes. Our solar panels may be installed on surfaces that are other than horizontal and remain effective solar energy collectors because the texture on the upper surface disburses, diffuses and refracts sunlight striking the panel causing the light rays to strike the photoreceptors under a strong transparent weight bearing surface.

Our system is comprised of a plurality of networked trafficable solar panels. Each panel is comprised of plural layers laminated together including a textured upper surface layer and one or more underlying layers. Each solar panel is able to withstand various weather conditions including expansion and contraction due to thermal variations, is trafficable, and is securable to a supportive surface by a variety of means.

The upper textured surface layer may be traveled upon and provides good traction under various weather conditions, and may also provide aesthetically appealing surface configurations. The solar panel may be heated by internal heating means in cold climates to prevent ice and snow accumulation on the upper surface. The upper surface layer is constructed of a material that passes light to photovoltaic cells thereunder while providing sufficient strength and integrity to support traffic thereon. The transparent upper surface passes sunlight therethrough even when the solar panel is positioned other than oriented perpendicular to the Sun's rays.

A circuit board comprising electronic circuitry of the solar roadway panel including circuitry, cabling, interconnection plates and the like is positioned under the textured surface layer.

The solar panels are operatively interconnected to allow electricity collected by the photovoltaic cells within a solar roadway panel to be stored and distributed as desired. The networked solar roadway panels also sense, collect and distribute various signals including, but not limited to, dynamic conditions surrounding the solar roadway panels, the presence and absence of traffic/vehicles/objects on or near the trafficable solar roadway panels, communications, digital data, inductive charging for vehicles, internet connections, telephone information, data and the like. The solar roadway panels may communicate with one another and with traffic (pedestrians, vehicles, etc.) wirelessly and also by wired means.

The solar panels are illuminated using internally carried light emitting diodes (LED's). Illumination of selected LEDs allows the system to “paint” lines and information on the panels at desired locations by activating and deactivating selected LEDs as desired for instance to widen, narrow or re-route traffic lanes as well as for displaying words such as “SLOW DOWN”, “CAUTION”, “DETOUR”, holiday decorations, aesthetically appealing designs and the like on the panels.

Each solar roadway panel has at least one controller, which may be, but is not limited to, a microprocessor, each controller has a unique identification code. Because the solar panels are networked with one another and with the power and signal distribution grid, the controllers may also be networked together which allows networked communication with each and every individual solar panel so that information and data may be shared.

During daylight hours the photovoltaic cells convert sunlight energy striking and passing through the transparent textured upper layer into electrical energy, and store the electrical energy in large value capacitors, batteries or other known electricity storage devices as desired. The energy may be used to power the controller, illuminate the LEDs contained within the panel and to heat the panel to prevent accumulation of snow and ice thereon. The energy may also be converted to alternating current (AC) by an inverter and then be sent for distribution to a power grid.

A nationwide network of such traffic bearing solar panels would, for example, allow the west coast to supply electricity to the east coast for several hours after the sun goes down on the east coast. Likewise, the east coast could generate electricity for the west coast for the first few hours of each day when the sun has risen in the east but has not yet risen in the west.

Research has shown that commercially available photovoltaic cells have approximately 15% efficiency; the US averages about 4 hours of peak sunlight hours per day (1460 hours per year); and one square mile of solar panels would generate approximately 37.76 Mega-Watts of electricity per year.

If the approximately 25,000 square miles of trafficable surfaces in the United States were replaced with the instant solar panels, over 13,417 billion Kilowatt-hours of electricity could be generated per year.

According to the Energy Information Administration, the United States consumed just over 4,372 billion Kilowatt-hours of electricity in 2003, while the entire world (including the U.S.) consumed approximately 14,768 billion Kilowatt-hours of electricity total. The instant system is capable of producing more than three times the total electricity usage of the entire United States.

Other contemplated uses for our trafficable solar panels include fixed rooftop installations, such as replacing standard asphalt shingles and/or roof tiles. Changing the configuration of the surface texture on the upper surface creates an aesthetically appealing surface and the ability to form the solar panels with curvilinear surfaces (e.g., roof tiles) increases the number of potential uses. Lighting and heating within the solar panels provides for additional uses including decorating and snow and ice removal. Use on swimming pool decks and even inside swimming pools, which are typically not overly utilized and are typically only foot traffic bearing may make swimming pools more commercially and environmentally friendly, as well as creative and interesting as the public seems to always be fascinated by illuminated water.

Further, it is envisioned the trafficable solar panels may be installed on existing supportive surfaces that are otherwise relatively unused, such as, but not limited to bike paths and the space between railroad tracks because such supportive surfaces are planar, relatively protected and relatively unused. Further, the space between railroad tracks extends nationally across the country.

Piezo electric sensors, and other known sensors, included within each solar panel, or remotely from each solar roadway panels, sense changing dynamic conditions such as, but not limited to, the presence of traffic (vehicles, pedestrians, animals, etc.) changing electromagnetic fields, changing electromagnetic radiation, temperature, moisture, GPS location and may be used for data and information and communication as well as for generating electricity in addition to the solar panels.

### III. SUMMARY

An intelligent solar roadway system of pedestrian and vehicular traffic bearing solar panels for collecting and transforming solar energy to electric energy, providing the electrical energy for use and for providing information to and receiving information from pedestrians and vehicles traveling upon the intelligent solar roadway system, comprising: a multiplicity of operatively and physically interconnected traffic bearing solar panels secured on a supportive surface so that each of the traffic bearing solar panels has at least one edge portion immediately adjacent at least one edge portion of an immediately adjacent traffic bearing solar panel to form a generally planar, continuous, trafficable surface for pedestrian and vehicular traffic travel thereover, each of the multiplicity of traffic bearing solar panels having; a transparent traffic bearing surface with a first upper glass panel and a second panel and a plurality of spacedly arrayed photovoltaic cells, a plurality of spacedly arrayed illumination devices, a heating element and electronic circuitry between the first upper glass panel and the second panel, a controller that operatively communicates with the electronic circuitry, the plurality of illumination devices, the heating element, an electric energy storage apparatus, at least one sensor that senses dynamic conditions, and with controllers of other traffic bearing solar panels of the intelligent solar roadway system for communication therebetween, and for providing information to, and receiving information from, vehicles and pedestrians traveling upon, or proximate to, the traffic bearing solar panels, and wherein the controller, directs electrical energy to select illumination devices to cause illumination thereof, and/or to the heating element, and/or to an inverter to convert direct current electricity from the plurality of photovoltaic cells to alternating current electricity and/or to convert alternating current electricity to direct current electricity for use, and a base for mechanically interconnecting each traffic bearing solar panel to the supporting surface for formation of the generally planar, continuous, trafficable surface; and each traffic bearing solar panel has a multiplicity of predetermined surface sections, and when the traffic bearing solar panel is secured to the supporting surface, each of the multiplicity of predetermined surface sections has a single precise global positioning system (GPS) location; and the at least one sensor, in communicating with the controller, senses the physical presence of a pedestrian and/or vehicle traveling upon, or adjacent to, the traffic bearing solar panel and the single precise GPS location of the predetermined surface section being traveled upon, and communicates the sensed presence and/or the single precise GPS location to the controller; and each respective controller, utilizing the single precise GPS location received from the respective sensor, determines a current position, a current direction and a current velocity of the pedestrian and/or vehicular traffic traveling upon the respective predetermined surface section of the traffic bearing solar panel and based upon the determined current position, determined current direction and determined current velocity, and a known prior position, a known prior direction, and a known prior velocity of the pedestrian and/or vehicular traffic traveling upon the traffic bearing solar panels the respective controller determines a predicted future position and/or a predicted future direction and/or a predicted future velocity of the pedestrian and/or vehicular traffic traveling upon the respective predetermined surface section of the traffic bearing solar panel, and the respective controller communicates the predicted future position and/or the predicted future direction and/or the predicted future velocity to controllers of adjacent and other traffic bearing solar panels; and the respective controllers operatively communicate the determined current position, current direction and/or current velocity and the predicted future position and/or direction and/or velocity of the pedestrians and/or vehicular traffic traveling upon the traffic bearing solar panels to the pedestrian and vehicles traveling upon the solar roadway panels so that the pedestrians and vehicles traveling upon the traffic bearing solar panels receive and may utilize the communicated and received information to control and/or alter control of the pedestrian and/or vehicle traveling upon the intelligent solar roadway system automatically or manually.

A further aspect of the instant invention is an intelligent solar roadway system wherein the sensor is integral within each traffic bearing solar roadway panel.

A further aspect of the instant invention is an intelligent solar roadway system wherein the sensor is remote from the traffic bearing solar panel.

A further aspect of the instant invention is an intelligent solar roadway system wherein the sensor is a pressure sensor that detects changes in weight.

A further aspect of the instant invention is an intelligent solar roadway system wherein the sensor is a piezo-electric device.

A further aspect of the instant invention is an intelligent solar roadway system wherein the sensor is an electromagnetic field (EMF) detector.

A further aspect of the instant invention is an intelligent solar roadway system wherein the sensor is a proximity sensor.

A further aspect of the instant invention is an intelligent solar roadway system wherein the sensor is a photo-optic sensor.

A further aspect of the instant invention is an intelligent solar roadway system wherein the sensor is a temperature sensor.

A further aspect of the instant invention is an intelligent solar roadway system wherein the sensor is a moisture sensor.

A further aspect of the instant invention is an intelligent solar roadway system wherein the sensor is an electromagnetic radiation (EMR) detector.

A further aspect of the instant invention is an intelligent solar roadway system wherein the precise current GPS location and precise predicted future GPS locations provided to the vehicle traffic traveling over the intelligent solar roadway system allows the vehicle to operate autonomously using the precise current and precise predicated future GPS locations.

A further aspect of the instant invention is an intelligent solar roadway system wherein the precise current and precise predicted future GPS locations provided to the vehicle traffic traveling over the intelligent solar roadway system is communicated to a smart-phone for use by a user.

A further aspect of the instant invention is an intelligent solar roadway system further comprising plural sensors integral with each traffic bearing solar roadway panel and plural sensors remote from the traffic bearing solar roadway panel, the plurality of sensors sensing dynamic conditions about the traffic bearing solar panels and communicating the sensed dynamic conditions to the controller.

A further aspect of the instant invention is an intelligent solar roadway system further comprising an external electric power source operatively communicating with each traffic bearing solar panel to receive electrical energy from the interconnected traffic bearing solar panels and to provide electrical energy to the plurality of interconnected traffic bearing solar panels.

a still further object to provide an intelligent roadway system and solar roadway panels that is of new and novel design, of rugged and durable nature, of simple and economic manufacturer and one that is otherwise well suited to the uses and purposes for which it is intended.

Other and further objects of our invention will appear from the following specification and accompanying drawings which form a part hereof.

In carrying out the objects of our invention it is to be understood that its steps, methods, structures and features are susceptible to changes in design, arrangement and order, with only one preferred and practical embodiment of the best known mode being illustrated in the accompanying drawings and specified as is required.

### IV. BRIEF DESCRIPTIONS OF DRAWINGS

In the accompanying drawings which form a part hereof and wherein like numbers refer to similar parts throughout:

FIG. 1 is an artist's representation of a downward looking plan view of plural networked solar panels extending about an intersection of roadways, driveways and buildings.

FIG. 2 is an orthographic exploded cross-section view of a trafficable solar panel showing the components thereof and a person's feet thereon representing pedestrian traffic upon a representative panel.

FIG. 3 is an orthographic exploded cross-section view of a trafficable solar panel showing the components thereof and a vehicle tire thereon representing vehicular traffic upon a representative panel and showing sensors positioned remotely from the panel, such as in a guard rail.

FIG. 4 is an artistic representation orthographic side view of a motor vehicle traveling along and upon the plurality of interconnected solar roadway panels with communication signals being exchanged between the vehicle and the solar roadway panels.

FIG. 5 is a simplified plan view of a portion of a solar roadway panel showing the plurality of photovoltaic cells and a plurality of illumination devices electrically interconnected to circuitry with a heating element.

FIG. 6 is an orthographic plan view of a representative solar panel having an identified plurality of illumination devices energized to display a message on the roadway panel.

FIG. 7 an orthographic plan view of a representative controller chip.

FIG. 8 is an orthographic plan view of two spacedly adjacent, aligned, solar roadway panels showing how the solar roadway panels may interconnect using dowels and aligned holes and showing the surface sections each with a single precise GPS location.

FIG. 8A is an orthographic side view of the two spacedly adjacent and aligned solar roadway panels of FIG. 8.

FIG. 9 is a block diagram of the interactive components with data communication exchanged therebetween.

FIG. 10 is an orthographic cross sectional view of the solar roadway system integrated with a storm water control system.

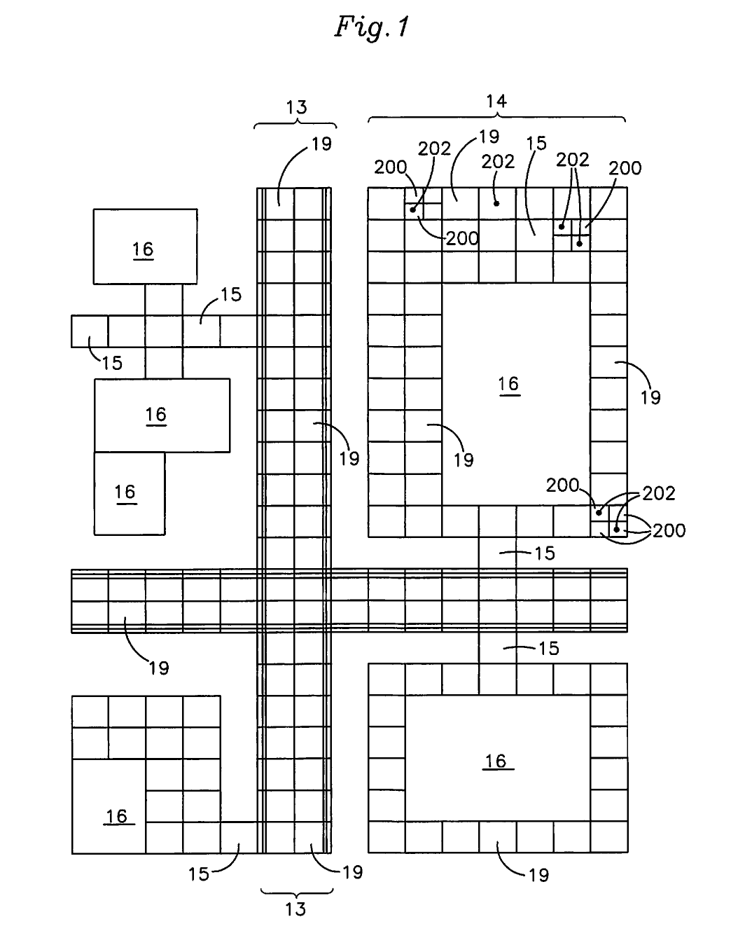

### V. DESCRIPTION OF PREFERRED EMBODIMENT

It is to be understood that the present invention is not limited to the particular methodology, compounds, materials, manufacturing techniques, shapes, surface textures, uses and applications described herein, as these may vary. It is also to be understood that the terminology used herein is used for the purposes of describing particular embodiments only, and is not intended to limit the scope of the present invention.

Unless defined otherwise, all technical scientific terms used herein have the same meanings as commonly understood by one of ordinary skill in the art in which this invention belongs. Preferred methods, techniques, devices and materials are described, although any methods, techniques, devices, or materials similar or equivalent to those described herein may be used in the practice or testing of the present invention. Structures described herein are to be understood also to refer to functional equivalents of such structures. All references cited herein are incorporated by reference in their entirety.

The word “controller” when used in the context of the present invention, includes any device capable of controlling components of the present invention, including, but not limited to, sending data, and/or receiving data. A controller may communicate with other controllers and/or with external data transmitters, sensors and/or receivers and may communicate with such other controllers/data transmitters/sensors and/or receivers wirelessly, and/or with wires and/or optically. As used herein, a controller expressly encompasses a microprocessor, which may have an integrated transmitter and/or an integrated receiver, but is not limited to a microprocessor.

The words “electrical storage device” when used in the context of the present invention, includes any device capable of storing an electric charge. The storage device may include a capacitor, or a battery, or other device storing electrical potential including but not limited to an external electricity generation, supply and distribution grid.

The words “communicating”, “coupled”, “associated” and any derivation thereof relating to the interaction between the components and include both wireless and non-wireless means and further includes, and is not limited to, optical means.

The words “sending”, “receiving” and any derivation thereof include both wireless and non-wireless and optical means.

Our intelligent solar roadway system and solar roadway panels provide plural networked solar roadway panels 19 that form a generally planar and generally continuous trafficable surface that may include but not be limited to driveways 15, parking lots 14, roads 13 and the like. Each solar roadway panel 19 generally comprises a surface layer 20, a circuit board 60 and a backplane 100. The three layers 20, 60, 100 are joined together, preferably laminated together, creating a water-tight and debris tight seal (not shown) to prevent water penetration, contaminant penetration, electrical shorts, and the like.

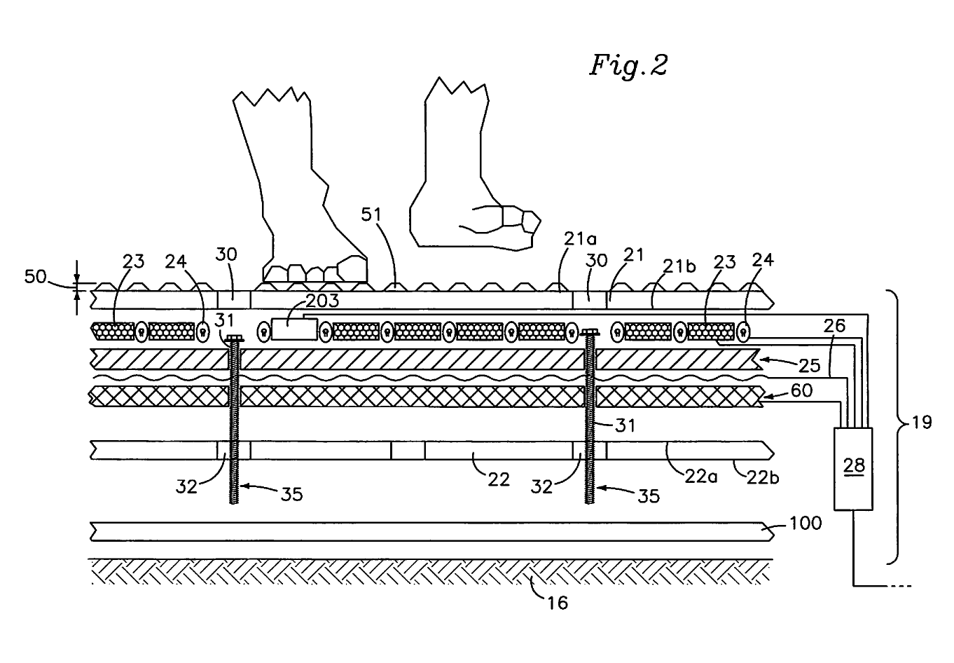

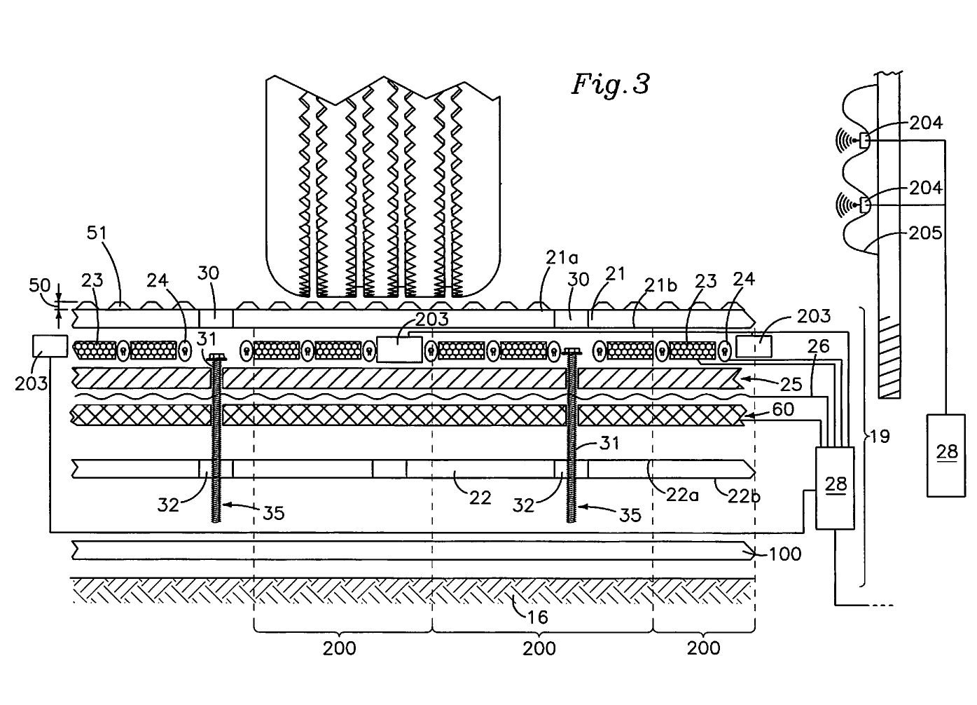

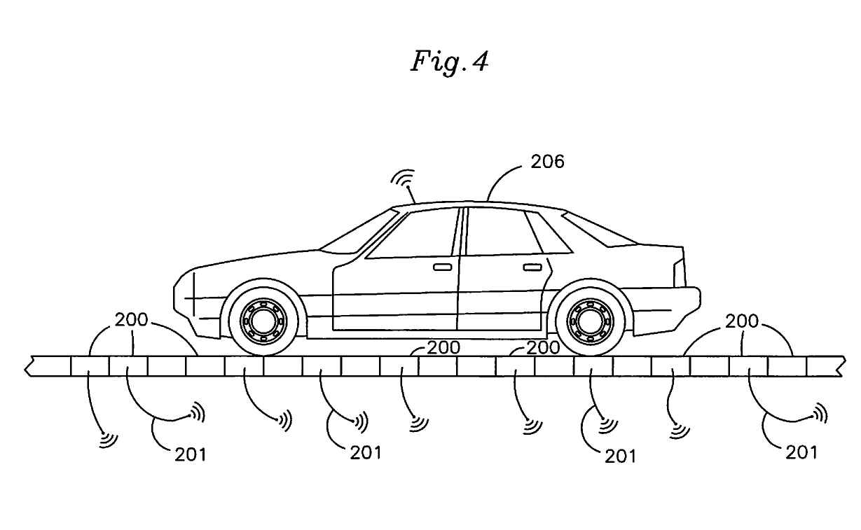

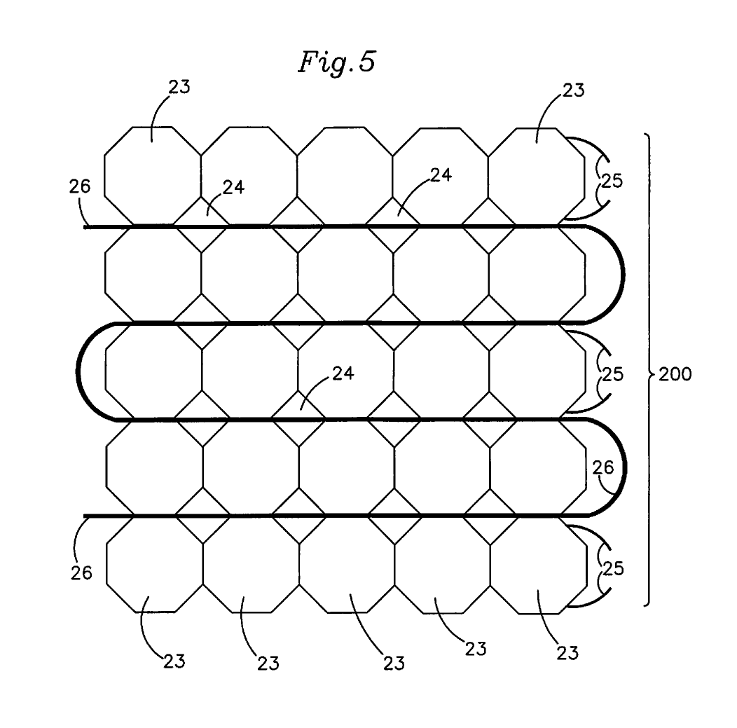

As shown in FIGS. 2 and 3, in the preferred embodiment, the solar panel 19 is comprised of a first glass panel 21 forming the surface layer 20 and a second panel 22. The first glass panel 21 has a top surface 21a and an opposing bottom surface 21b. Similarly, the second panel 22 has a top surface 22a and a bottom surface 22b.

The first glass panel 21 forming the surface layer 20 serves multiple purposes, including being the traffic bearing surface for a vehicle's tires or a pedestrian's feet, as well as providing a transparent interface for underlying photovoltaic cells 23. It is essential that the first glass panel 21 satisfy the requirements of transparency, mechanical reliability, weather resistance, wear resistance, durability and traction, as well as other known requirements.

The first glass panel 21 must be capable of passing solar light to the plurality of spacedly arrayed photovoltaic cells 23 which are positioned under the first glass panel 21 and above the second panel 22. The surface layer 20 must also maintain the strength and integrity required for supporting vehicles, and must provide waterproof protection to the circuit board 60.

The transparency of the first glass panel 21 is necessary for the inward passing of solar energy to the underlying photovoltaic cells 23 and also for the outward passage of visible light from illumination devices 24 such as, but not limited to, light emitting diodes (LEDs) 24 communicating with circuitry 25 between the first glass panel 21 and the second glass panel 22 and spacedly arrayed about the photovoltaic cells 23.

In the preferred embodiment, glass is the material of choice for the first glass panel 21 and the second glass panel 22 because the optical properties of glass, in contrast to plastic, are stable against solarization (long term darkening) and other ultra-violet light induced mechanisms of material degradation. In addition, glass produces a lower carbon footprint compared to comparable plastics, glass is recyclable and glass may be formed into a variety of shapes and configurations with a variety of surface texture configurations including, but not limited to, hexagons, scallops and numerous other shapes and designs for texture, for aesthetic appeal and for light diffusion to the photovoltaic cells 23 so that light need not strike the panels 19 perpendicularly.

With more particularity, the preferred embodiment uses low iron float glass such as, but not limited to, Borofloat™, produced by Shottglass™, Inc. or Starfire™, manufactured by PPG®. Borofloat™ is known for having a minimal thermal expansion co-efficient which makes Borofloat™ an appealing material. Other possible surface layer 20 materials include, but are not limited to, “rolled” soda lime glass and laminated float glass which may have multiple layers to provide for higher performance, higher reliability, noise absorbsion, thermal shock resistance and the like. It is known that use of one or more engineered polymer interlayers can yield glass laminates with one hundred times (100×) the stiffness and five times (5×) the strength of standard float glass. Further, any polymer layers may be ultra-violet light resistant, they are temperature stable and they provide an edge protection to the laminates. Further, it is known to print thin film electro-optics directly on polymer interlayers. The printed thin film electro optics can create the necessary photovoltaic cells 23.

The precise nature of the first glass panel 21 is critical as it will be exposed to microscopic impact stresses from traffic, and Hertzian contact stresses generated at the surface by sharp objects such as, but not limited to, road grit and stones lodged in vehicle tires, hail stones and wind driven debris. Impact stresses can cause failure of the first glass panel 21 and cause cracks therein, while Hertzian contact stresses may generate cone cracks which weaken the first glass panel 21 and may lead to eventual failure. Further, damage such as scratches, cracks and the like in the first glass panel 21 will diminish the optical properties and optical transparency of the first glass panel 21 reducing the efficiency of the photovoltaic cells 23.

In the preferred embodiment, the first glass panel 21 is treated to minimize susceptibility to surface damage. In one embodiment, the first glass panel 21 is treated with a wear resistant coating such as, but not limited to, the diamond coated commercial float glass by Guardian® Industries. A second option is to use strengthened glass which is tempered or ion exchanged, to possess a pre-stressed compressive layer at the surface that resists impact and related contact damage. Further, strengthened glass may be textured prior to hardening to enhance traction capabilities. In the preferred embodiment the first glass panel 21 has a Moh's hardness rating of at least 6.0.

With more particularity, in the preferred embodiment, a laminated low iron float glass, that is preferably between approximately ⅛″ thick and ¾″ thick is used for the first glass panel 21 because it is strong, durable and optically transparent. Further, float glass is safe and is capable of withstanding various of the envisioned, projected and anticipated impact loads for a trafficable surface.

Further still, the recyclability of glass, its manufacture using plentiful raw materials and current government initiatives to lower energy costs and CO2 footprint also supports use of low iron float glass.

Carried between first glass panel 21 and second panel 22 is a plurality of spacedly arrayed photovoltaic cells 23, a plurality of spacedly arrayed light emitting diodes (LED's) 24 and electric circuitry 25 for the functioning of the photovoltaic cells 23 and LEDs 24 and other components such as, but not limited to, sensors 203 which may be, but are not limited to, pressure sensors (not shown), Piezo electric modules (not shown), Pelletier devices (not shown) and a GPS location transmitter 201.

A heating element 26 communicates with the circuit board 60 and provides a means for heating the solar panel 19 and its components to prevent ice and snow accumulation thereon when the panel 19 is exposed to freezing conditions. The electric circuitry 25 for operating the heating element 26, the photovoltaic cells 23 and the LEDs 24 and the sensor 203 and of the GPS location transmitter 201 pass through a wiring orifice (not shown) defined in the second panel 22 to operatively connect with electrical storage device 27 and other components, such as other controllers 28.

Known photovoltaic cells 23, also known as solar cells and as photoreceptors, are most efficient when oriented directly at the sun so that solar rays strike the photovoltaic cells 24 perpendicularly. Testing has reinforced this understanding, but also revealed that on overcast and cloudy days, that horizontally installed solar panels 19 generate more electricity than solar panels oriented toward the sun. It is believed this increase in electrical production is caused by the scattering and diffusion of solar rays striking moisture droplets in the air. Further, testing has revealed that automobile headlights shining on horizontally aligned solar panels 19 also generated some levels of electricity. Surface texture 50 including a preferred hexagonal shaped protrusions 51 on the upper surface 21a of the first glass panel 21 cause refraction and diffusion of light waves striking the panel 19 which enhances generation of electricity and increases the efficiency of the panels 19. Experiments have shown the protrusions 51 which cause the first glass panel 21 to have varying thicknesses across its upper surface 21a, enhance the light refraction and diffusion causing more of the lights to strike the photovoltaic cells 24 than if the upper glass panel 21 was planar without protrusions 51.

In the preferred embodiment, the photovoltaic cells 23 are monocrystalline solar cells that are commercially available. The monocrystalline photovoltaic cells 23, although only having an efficiency of approximately 14.47% are known to be durable, inexpensive, and are readily commercially available. It is recognized however that photovoltaic cells 23 having efficiency ratings in the 42% plus range are known and improvements in efficiency continue. An alternative to monocrystalline photovoltaic cells 23 is using known thin film solar cells which are formed by depositing one or more thin layers of photovoltaic material on a substrate. One benefit of thin film solar cells is that the photovoltaic material may be deposited on the substrate using known chemical vapor deposition techniques. The thin-film photovoltaic cells (not shown) are presently less expensive than monocrystalline photovoltaic cells 24, but are also less efficient in generating electricity. In the preferred embodiment the plurality of photovoltaic cells 23 are soldered or otherwise electrically and structurally attached to the circuit boards 60 in spaced array.

Known electric circuitry 25 and the circuit board 60 communicate with the plurality of photovoltaic cells 23 to allow the energy generated within the photovoltaic cells 23 to be passed to an electrical storage element 27, to the electrical grid (not shown) to the controller 28, to the plurality of light emitting diodes 24, to the heating element 26, to the sensor 203, to the GPS location transmitter 201 and to other operably interconnected components. The heating element 26 is preferably attached to bottom surface of the circuit board 60 such as with an adhesive. An electrical connection, which may be a wire or the like (not shown), communicating with the circuit board 60 may communicate through a hole (not shown) defined in the second panel 22 to communicate with the external power grid (not shown) or with an external storage element 27.

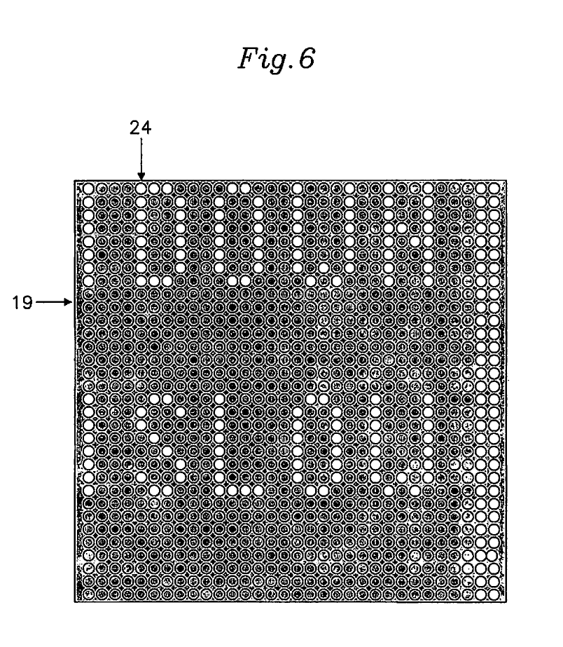

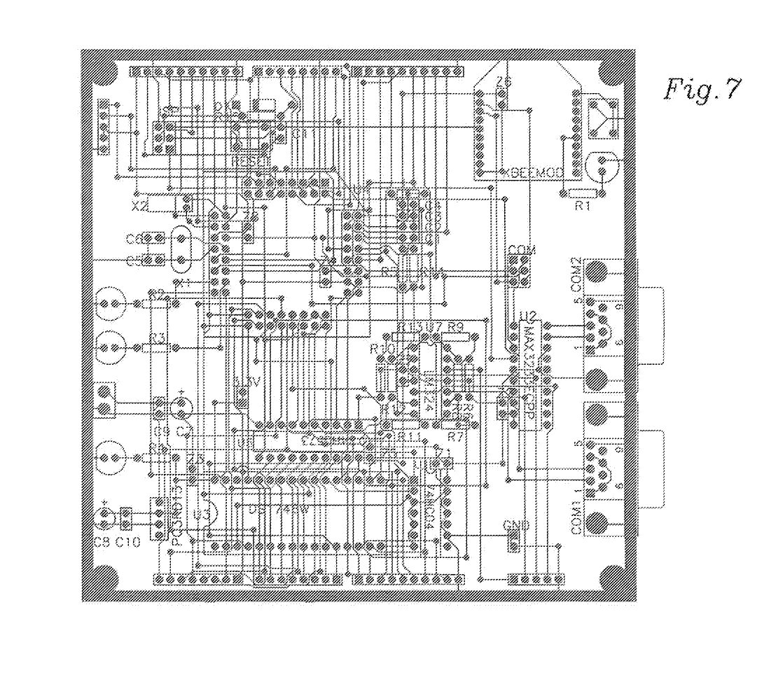

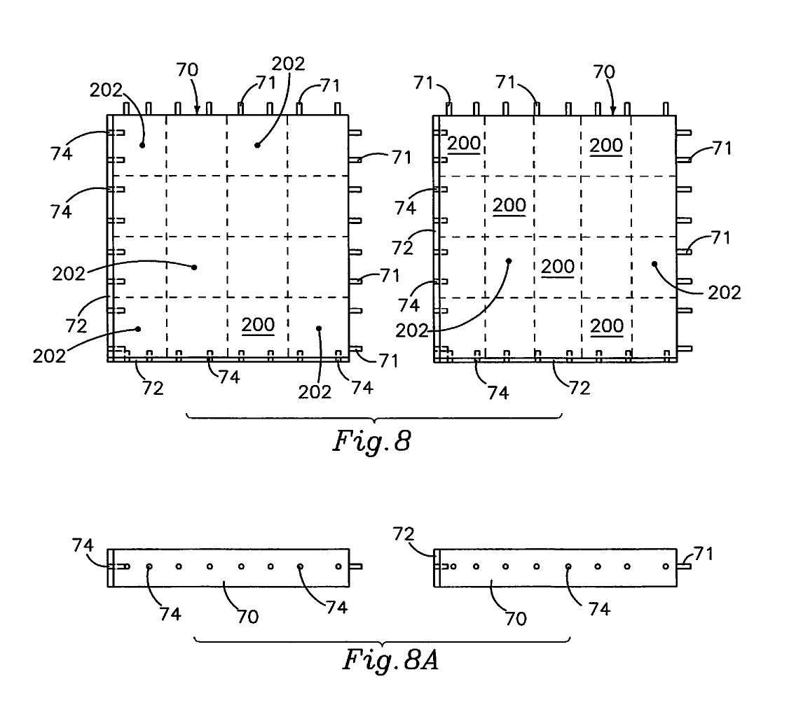

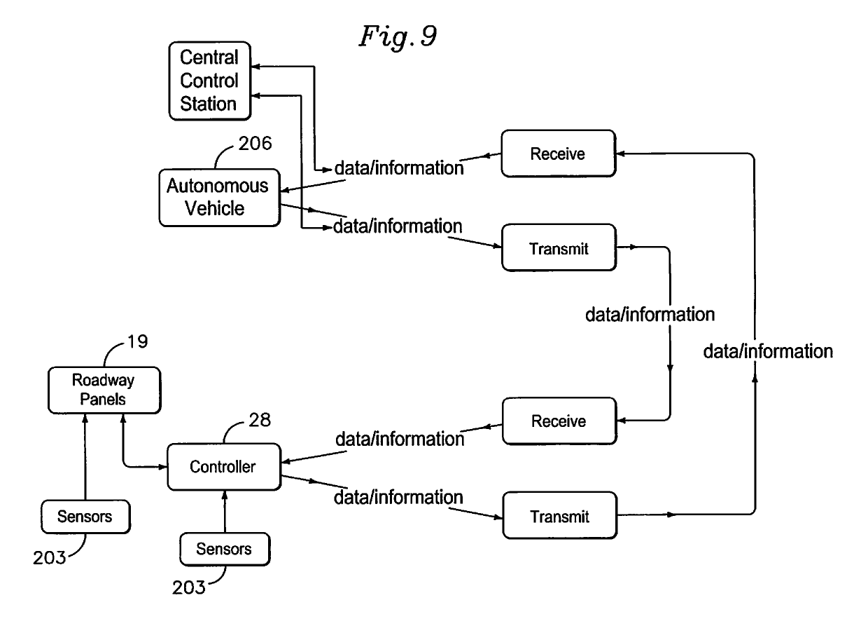

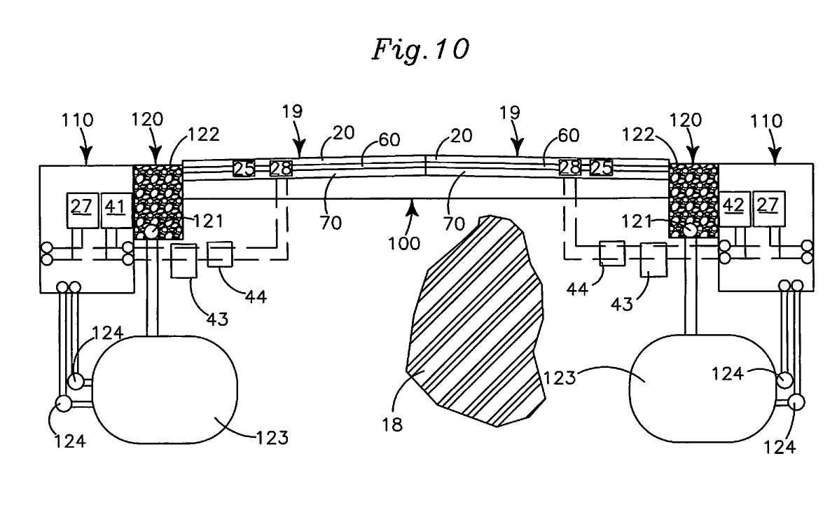

The plurality of LEDs 24 operably communicate with the circuit board 60 and are spacedly arrayed between the photovoltaic cells 23. Similar to the photovoltaic cells 23, the plurality of LEDs 24 also electrically communicate with the circuit board 60, with electrical circuitry 25 communicating therewith and therebetween. The LEDs 24 communicate with the controller 28 through known electric circuitry 25 so that selected LEDs 24 may be illuminated in desirable patterns, including lines, words, patterns and the like. (See FIG. 6). It is anticipated that the plurality of LEDs 24 will be colored, including but not limited to yellow and white to represent existing painted road information and the color variation may be accomplished by using different types of LEDs 24 that emit different wavelengths (different colors) of light, or by using colored lenses (not shown) surrounding the LEDs 24 so that light waves emitted by the LEDs 24 must pass through the colored lenses (not shown) before passing out of the solar roadway panel 19 for visualization.

A controller 28 communicating with the LEDs 24 sorts signals and responsively illuminates and de-illuminates select LEDs 24 as determined by the controller 28. It is also anticipated that other forms of low power illumination devices may also be used in place of the plurality of LEDs 24. Known photo resistors (not shown) may be electrically interconnected with the LEDs 24, to the photovoltaic cells 23, to the electrical storage element and to the controller 28 to vary the illumination intensity of the LEDs 24 responsive to ambient lighting conditions. For example the LEDs 24 may need to be more intense/brighter during daylight hours to be clearly visible, and may need to be less intensely illuminated/dimmer during hours of darkness. A photosensor (not shown) within the solar panel 19 may assist with such brightening and dimming.

Autonomous vehicles 206 (vehicles lacking a physically present human operator) are becoming more popular and legislation is being introduced and implemented in a variety of jurisdictions to allow the operation of such autonomous vehicles upon roadways.

Autonomous vehicles 206 generally use a combination of a plurality of sensors (not shown) and computer software (not shown) to continually determine the vehicle's geographic location, position and orientation combined with sophisticated and accurate digital maps. A global positioning system (GPS) is employed, similar to satellite navigation systems currently present in most vehicles, to provide a “generalized” location and orientation of the vehicle, at which point other sensors, such as radar, lasers, cameras and the like are employed to monitor the surroundings of the vehicle in a 360° sphere. Unfortunately, known GPS-based techniques are not sufficiently accurate, and the position of the vehicle may vary by “several meters” or so which is not sufficiently accurate to provide a acceptably safe autonomous operation of motor vehicles 206.

An additional concern with current GPS systems used for navigating and controlling autonomous vehicles is that various governmental agencies, such as, but not limited to the Department of Defense (DOD) has the capability and authority to interrupt/turn off the satellite systems at its discretion. Autonomous vehicles 206 that rely on such GPS systems, that may be interrupted/turned off are therefore not acceptably safe.

Our intelligent roadway of operably interconnected solar roadway panels 19 has integral sensors 203, and remotely position sensors 204, that communicate with a vehicle 206 passing thereover to provide an alternative to known GPS-based systems. The sensors 203, 204 each have a single precise fixed longitude, latitude and altitude position (GPS position 202) that can be communicated to the vehicle 206 traveling thereover. The precise single GPS location 202 of the sensor 203, 204 eliminates the variability of the known GPS systems. Further, the continuity and preciseness of the sensor location eliminates the inaccuracy of current GPS systems and is less likely to be interruptible by governmental agencies, or “hacked”, or the like.

Nearly all modern motor vehicles operate using a Controller Area Network (CAN bus) which is a robust vehicle bus standard designed to allow microcontrollers and devices to communicate with one another in applications without a host computer. CAN bus is a message based protocol, originally designed for multiplex electrical wiring within automobiles. CAN bus is a multi-master serial bus standard for connecting Electronic Control Units (ECUs) which are also known as “nodes”. (Not shown). The complexity of a node (not shown) can range from a simple I/O device up to an embedded computer with a CAN interface and sophisticated software. The node may also be a gateway allowing a standard computer to communicate over a USB or Ethernet port to the devices on the CAN network.

A modern automobile may have as many as 70 electronic control units (ECUs) for controlling various subsystems including, but not limited to, the engine, transmission, airbags, antilock braking systems, cruise control, electronic power steering, audio systems, power windows, and recharging systems for hybrid/electric vehicles and the like. A subsystem may control various actuators within the vehicle, such as steering, acceleration, deceleration and the like and each subsystem receives feedback from various sensors within the vehicle. The interconnection between different vehicle systems allows for a wide range of safety, economy and convenience features to be implemented using software alone. Examples include, but are not limited to:

Auto start/stop: Various sensory inputs from around the vehicle (speed sensors, steering angle, air-conditioning on/off, engine temperature) are all collected via the CAN bus to determine whether the engine can be shut down when stationary for improved fuel economy and emissions. One example is smart technology that allows eight cylinder engines to “turn off” two or four cylinders during low load operations to save fuel;

Parking assist systems: when the driver engages reverse gear, the transmission control unit can send a signal via the CAN bus to activate both the parking sensor system, and the door control module for the passenger side door mirror to tilted downwards to show the position of the curb. The CAN bus also takes inputs from the rain sensor to trigger the rear windscreen wiper when reversing;

Auto Lane assist/collision avoidance systems: the inputs from the parking sensors are also used by the CAN bus to feed outside proximity data to driver assist systems such as lane departure warning, and more recently, the signals travel through the CAN bus to actuate brake-by-wire in active collision avoidance systems; and

Auto break wiping: input is taken from the rain sensor (used primarily for automatic windscreen wipers) via the CAN bus to the ABS module to initiate an imperceptible application of the brakes whilst driving to clear moisture from the brake rotors.

CAN bus protocol is not limited to motor vehicles and has also been used in bicycles to control gear shifting systems.

CAN bus is one protocol that is capable of controlling vehicle steering, the vehicle transmission and the vehicle braking. In other words, the CAN bus system can accelerate, brake, and turn the vehicle. A motor vehicle can therefore be converted into an autonomous vehicle 206 through use of its existing CAN bus, an onboard control system (not shown) and the intelligent solar roadway system and solar roadway panels invention disclosed herein.

When such an onboard control system is interfaced with the sensors 203 embedded in the roadway 19, and remote sensors 204, then our intelligent roadway system has the capability of operating the vehicle safely and efficiently. The interconnection can be accomplished via wireless communication between the vehicle 206 and the intelligent roadway 19 and the controllers 28. As such, an operator might be able to enter his/her vehicle on such a road; enter the destination into the control panel; and the intelligent roadway would thereafter take control of the vehicle and guide the vehicle to the programmed destination, perhaps even finding a parking place an. Waking up the operator upon arrival.

In the preferred embodiment, there is at least one controller 28 per solar roadway panel 19 that receives signals (not shown) from other controllers 28 and/or from a central control station (not shown) causing the controller 28 to illuminate select LEDs 24 on the panel 19, such as to energize the heating element 26, to change road lane configurations, to provide visual warning messages (FIG. 6) and to provide information/data to pedestrians and/or vehicles 206 traveling upon the roadway panels 19. The controller 28 further allows the central control station (not shown) to monitor the status and operation of the networked and individual solar roadway panels 19 such as electrical production from the photovoltaic cells 23, and also whether there might be an obstruction (not shown) on the panel 19, by detecting signals from sensors 203 that may be included within the solar roadway panel 19 and sensors 204 remote from the solar roadway panels 19. Additional controllers 28 will increase the functionality of such panels 19.

Circuit board 60 communicates with the plurality of LEDs 24 and the plurality of photoreceptors 24 as well as the controller 28, wiring harnesses (not shown), other circuitry 25 and sensors 203, 204, that is necessary or desirable for operation of the roadway panel 19.

The circuit board 60 is sealed, preferably using liquid polyurethane, to hermetically seal the components together into a single structure. The hermetic sealing of the circuit board 60, its related components and electric circuitry 25 allows the solar roadway panel 19 to function/operate safely even when partially or completely submerged in water.

The upper glass panel 21, the lower glass panel 22, and the circuit board 60 all define at least one fastener hole 30, 31, 32 therein, respectively, which are aligned. In the preferred embodiment, diameter 33 of fastener hole 31 defined in the circuit board 60 is smaller than diameter 34 of the fastener hole 30 defined in the first glass panel 21 which provides a “shoulder” (not shown) with which a head portion of a threaded fastener 35 may frictionally engage to positionally secure the panel 19 to a supportive surface. (See FIGS. 2, 3). It is expressly contemplated plural aligned fastener holes 30, 31, 32 may be defined in spaced array about a panel 19 and plural threaded fasteners 35 may be used to positionally secure the panel 19.

In the second preferred embodiment it is contemplated using magnets (not shown), including but not limited to electromagnets and/or rare earth magnets such as neodymium magnets to positionally secure the panels 19 to a supportive surface 16 and to each other at adjoining edge portions. The magnets (not shown) may be carried within the panel 19 at spacedly arrayed positions to “attract” to other magnets (not shown) carried by the supportive surface 16 or to attract to a magnetically permeable material (such as steel bands/strips) carried by the supporting surface 16. In areas where the panels 19 are not subject to excessive sliding forces or lateral forces, such as bike paths and other areas of pedestrian traffic, including slightly pitched residential roofs 16, magnetic fastening of the panels 19 may be a preferred fastening means. In an even further embodiment, the solar panels 19 may be adhesively affixed to the supportive surface 16.

During daylight hours, the photovoltaic cells 24 will collect solar energy passing through the first glass panel 21 and convert that solar energy into direct current (DC) electrical energy. The photovoltaic cells 23 communicate, by means of electric circuitry 25 with an electrical energy storage device 27 such as a capacitor 41, but which may also be a battery 42 and may also be the external electrical grid. (Not shown). In the preferred embodiment, a capacitor 41 is used to avoid hazardous waste byproducts of batteries 42.

The direct current (DC) electricity generated by the photovoltaic cells 23 is fed into an inverter 43 for conversion of direct current (DC) electricity into alternating current (AC) electricity which may be thereafter fed into the electrical grid (not shown) or used, for example, in powering an electric appliance. (not shown). In the preferred embodiment, each panel 19 communicates with its own inverter 43 which allows each solar roadway panel 19 to produce electricity independently from the other solar roadway panels 19.

Independent operation of each solar roadway panel 19 allows the intelligent solar roadway and solar panel system to be scalable, meaning that a few solar roadway panels 19 may be purchased and installed initially and thereafter additional solar roadway's solar roadway panels 19 may be installed and interconnected with the system. Further, if a plurality of panels 19 are used to cover a driveway 15, only those panels 19 on which a vehicle 206 is parked would not produce electricity.

The direct current (DC) electricity generated by the photovoltaic cells 23 also provides energy to run the controller 28, the LEDs 24, the heating element 26, and other components of the panel 19 including, but not limited to, sensors 203, 204 within the panel 19 such as, but not limited to pressure sensors, temperature sensors, proximity sensors, electromagnetic radiation sensors, electromagnetic field sensors, piezo-electric modules, optical sensors, and the like, all of which may be used to detect and monitor pedestrian and vehicle traffic upon the solar roadway panels 19. Excess energy generated by the photovoltaic cells 23, over and above the amount of energy necessary for the operation of components of the roadway panel 19 is diverted to the electrical energy storage element 27, or to the electrical grid (not shown) as directed by the controller 28 and a central control station (not shown).

The solar panel 19 may be illuminated by energizing the LEDs 24 embedded in the panels 19 using the energy stored within the electrical energy storage element 27, or with electricity received from the electrical grid (not shown). Illumination may occur during all hours including daylight hours as well as night time hours.

The electrical energy storage element 27 is preferably a capacitor 41 and more preferably an ultra capacitor that has the ability to store sufficient energy to function similar to a battery 42. Cooper Bussman™, Inc. is one company that is presently manufacturing such ultra capacitors 41.

Alternatively, batteries 42, or other know electricity storage devices, may also be used to store the generated electricity and to power the roadway panels 19 and components during daylight and non-daylight hours.

Each controller 28 has a unique identification number that is capable of communicating wirelessly, or via wires, or optically (not shown) with other controllers 28, with a central control station (not shown) and with traffic traveling on the roadway panels 19. Because each panel 19 interconnects with a power system and a signal distribution system, the controllers 28 are networked together forming a wide area network (WAN) which allows the central control station (not shown) to monitor real-time dynamic conditions, problems, operation functions and vehicular and pedestrian traffic.

The controller 28 controls the panel 19, including operation of the heating element 26, to monitor the temperature of the panel 19, to energize the LEDs 24 to control the electrical input and output of the panel 19 and to provide precise GPS location data/information 202 to traffic traveling upon the roadway panels 19. Further, the controller 28 enables each roadway panel 19 to network with adjacent roadway panels 19 forming the WAN and also when so configured, the roadway panel 19 will monitor traffic over the panels 19, such as with radio frequency identification tags (not shown) within the vehicles and/or carried by pedestrians, such as “smart phones”. Further, the controller 28 allows the central control station (not shown) to selectively illuminate LEDs 24 embedded within the panel 19 to provide messages to traffic traveling upon the solar panels 19, including messages such as “slow down”, “caution”, holiday decorations, aesthetically appealing designs and traffic conditions ahead of, behind, and surrounding each vehicle 206.

The roadway panels 19 may be interconnected with a backplane 100 which is installed on the supportive surface 16 below the roadway panels 19. (FIG. 2). The backplane 80 may carry the electrical grid connections (not shown). In the further preferred embodiment the backplane 100 is configured with conduit (not shown) embedded therein for cables (not shown) to carry electrical power to and from the panels 19.

In a still further alternative embodiment, controllers 28 may use radio frequency signals to monitor radio frequency identification tags (RFID) (not shown) carried within vehicles 206. Such a system would allow the networked trafficable solar panels 19 to monitor the movement of vehicles 206, and perhaps persons thereon, and would provide a means for said vehicles 206 to operate autonomously as well as tracking business shipments, hazardous waste shipments and the like. Further, emergency vehicles having radio frequency transmitters (not shown) could broadcast signals (not shown) that are received by the controllers 28 which would thereafter activate a predetermined display of LEDs 23 to let users traveling on the networked trafficable solar panels 19 know that an emergency vehicle is approaching. Similarly, the signals may be used for other law enforcement and safety purposes. Further, wireless control capability will allow the networked solar panel system to control properly equipped vehicles.

In a further embodiment, load cells (not shown) installed within the panels 19 and controlled by the controller 28 may sense when a panel 19 is bearing a load, such as a person, which may be useful and for playing games with using illuminated panels 19 such as in parks, school playgrounds, patios, and the like. Since the panels 19 are networked, and the controllers 28 communicate with one another via the WAN, it is possible for the panels 19 to determine when a person and/or a vehicle is 206 and/or animal (not shown), and/or obstruction (not shown) is present upon or traversing a roadway panel 19 so that adjacent roadway panels 19 in the user the person is moving may illuminate creating a lighted path.

In a further alternative embodiment, cameras (not shown) may be carried within the panels 19 to take photographs. Because the first glass panel 21 is transparent, cameras (not shown) may be completely enclosed within the panel 19.

Because the network of solar panels 19 will be so widespread, the network is likely subject to a wide variety of environmental conditions including exposure to lightning strikes, and other sources of transient voltages such as, but not limited to, electronic rust that might cause damage to the solar panels 19 and the associated electric circuitry 25.

To protect the networked solar panels 19 from such transient voltages surge protection devices 44 are integrated into the electric circuitry 25. Such surge protection devices 44 typically utilize metal oxide varasitors, silicone avalanche diodes, gas tubes or combinations of like or similar components as a switch for diverting excess electrical current. Known types of such surge protection devices 44 each have advantages and disadvantages, and the selection of a particular type of surge protection device 44 will be dictated by the particular circumstances and location of the panels 19.

It is anticipated the networked solar panel 19 system will be financially self-sustaining, even though the initial cost of installing the solar panels 19 may be significant. It is anticipated a widely distributed intelligent solar roadway 19 system, once operational, will generate revenue through generation of electricity which is added to the electrical grid (not shown); by carrying signals such as communications, video and the like by providing advertisements in parking lots for instance; and by allowing persons to re-charge electric vehicles, such as by induction. Further, when used upon roads 13 the solar panels 19 will reduce road maintenance costs by eliminating the need to paint lines and stripes on road surfaces every year and by eliminating the need to plow snow and/or apply de-icing chemicals that contribute to pollution. These positive economic impacts may however be less than the global impact of reducing the need for burning fossil fuels to generate electricity which contributes to the greenhouse gas effect in the world which according to some experts is a leading cause of global warming and climate change.

An intelligent solar roadway system of pedestrian and vehicular traffic bearing solar panels for collecting and transforming solar energy to electric energy, providing the electrical energy for use and for providing information to and receiving information from pedestrians and vehicles traveling upon the intelligent solar roadway system, comprising: a multiplicity of operatively and physically interconnected traffic bearing solar panels secured on a supportive surface so that each of the traffic bearing solar panels has at least one edge portion immediately adjacent at least one edge portion of an immediately adjacent traffic bearing solar panel to form a generally planar, continuous, trafficable surface for pedestrian and vehicular traffic travel thereover, each of the multiplicity of traffic bearing solar panels having; a transparent traffic bearing surface with a first upper glass panel and a second lower glass panel and a plurality of spacedly arrayed photovoltaic cells, a plurality of spacedly arrayed illumination devices, a heating element and electronic circuitry between the first upper glass panel and the second lower glass panel, a controller that operatively communicates with the electronic circuitry, the plurality of photovoltaic cells, the plurality of illumination devices, the heating element, an electric energy storage apparatus, at least one sensor that senses dynamic conditions, and with controllers of other traffic bearing solar panels of the intelligent solar roadway system for communication therebetween, and for providing information to, and receiving information from, vehicles and pedestrians traveling upon, or proximate to, the traffic bearing solar panels, and wherein the controller, directs electrical energy to select illumination devices to cause illumination thereof, and/or to the heating element, and/or to an inverter to convert direct current electricity from the plurality of photovoltaic cells to alternating current electricity and/or to convert alternating current electricity to direct current electricity for use, and a base for mechanically interconnecting each traffic bearing solar panel to the supporting surface for formation of the generally planar, continuous, trafficable surface; and each traffic bearing solar panel has a multiplicity of predetermined surface sections, and when the traffic bearing solar panel is secured to the supporting surface, each of the multiplicity of predetermined surface sections has a single precise global positioning system (GPS) location; and the at least one sensor, in communicating with the controller, senses the physical presence of a pedestrian and/or vehicle traveling upon, or adjacent to, the traffic bearing solar panel and the single precise GPS location of the predetermined surface section being traveled upon, and communicates the sensed presence and/or the single precise GPS location to the controller; and each respective controller, utilizing the single precise GPS location received from the respective sensor, determines a current position, a current direction and a current velocity of the pedestrian and/or vehicular traffic traveling upon the respective predetermined surface section of the traffic bearing solar panel and based upon the determined current position, determined current direction and determined current velocity, and a known prior position, a known prior direction, and a known prior velocity of the pedestrian and/or vehicular traffic traveling upon the traffic bearing solar panels the respective controller determines a predicted future position and/or a predicted future direction and/or a predicted future velocity of the pedestrian and/or vehicular traffic traveling upon the respective predetermined surface section of the traffic bearing solar panel, and the respective controller communicates the predicted future position and/or the predicted future direction and/or the predicted future velocity to controllers of adjacent and other traffic bearing solar panels; and the respective controllers operatively communicate the determined current position, current direction and/or current velocity and the predicted future position and/or direction and/or velocity of the pedestrians and/or vehicular traffic traveling upon the traffic bearing solar panels to the pedestrian and vehicles traveling upon the solar roadway panels so that the pedestrians and vehicles traveling upon the traffic bearing solar panels receive and may utilize the communicated and received information to control and/or alter control of the pedestrian and/or vehicle traveling upon the intelligent solar roadway system automatically or manually.

It is further contemplated the sensor 203 is integral with the traffic bearing solar roadway panel.

It is further contemplated the sensor 204 is remote from the traffic bearing solar panel.

It is further contemplated the sensor 203 is a pressure sensor that detects changes in weight.

It is further contemplated the sensor 203 is a piezo-electric device.

It is further contemplated the sensor 203, 204 is an electromagnetic field (EMF) detector.

It is further contemplated the sensor 203, 204 is a proximity sensor.

It is further contemplated the sensor 203, 204 is a photo-optic sensor.

It is further contemplated the sensor 203, 204 is a temperature sensor.

It is further contemplated the sensor 203, 204 is a moisture sensor.

It is further contemplated the sensor 203, 204 is an electromagnetic radiation (EMR) detector.

It is further contemplated that the precise current and precise predicted future GPS locations 202 provided to the vehicle traffic 206 traveling over the intelligent solar roadway 19 system allows the vehicle 206 to operate autonomously using the precise current and precise predicted future GPS locations 202, and that the precise current and precise predicted future GPS locations are communicated to a smart phone (not shown) for use by the user.

It is still further contemplated the intelligent solar roadway system will further comprising plural sensors 203 integral with each traffic bearing solar roadway panel 19 and plural sensors 204 remote from the traffic bearing solar roadway panel 19, such as in a roadway guard rail 205 and the plurality of sensors 203, 204 sense static and changing dynamic conditions about the traffic bearing solar panels 19 and communicating the sensed dynamic conditions to the controller 28.

The intelligent solar roadway system may further comprise an external electric power source operatively communicating with each traffic bearing solar panel 19 to receive electrical energy from the interconnected traffic bearing solar panels 19 and to provide electrical energy to the plurality of interconnected traffic bearing solar panels 19.

Having thusly described our invention, what we desire to protect by Utility Letters Patent and

What we claim is:

We claim:

1. An intelligent solar roadway system of pedestrian and vehicular traffic bearing solar panels for collecting and transforming solar energy to electric energy, providing the electrical energy for use and for providing information to and receiving information from pedestrians and vehicles traveling upon the intelligent solar roadway system, comprising:
a multiplicity of operatively and physically interconnected traffic bearing solar panels secured on a supportive surface so that each of the traffic bearing solar panels has at least one edge portion immediately adjacent at least one edge portion of an immediately adjacent traffic bearing solar panel to form a generally planar, continuous, trafficable surface for pedestrian and vehicular traffic travel thereover, each of the multiplicity of traffic bearing solar panels having;
a transparent traffic bearing surface with a first upper glass panel and a second panel and a plurality of spacedly arrayed photovoltaic cells, a plurality of spacedly arrayed illumination devices, a heating element and electronic circuitry between the first upper glass panel and the second panel,
a controller that operatively communicates with the electronic circuitry, the plurality of illumination devices, the heating element, an electric energy storage apparatus, at least one sensor that senses dynamic conditions, and with controllers of other traffic bearing solar panels of the intelligent solar roadway system for communication therebetween, and for providing information to, and receiving information from, vehicles and pedestrians traveling upon, or proximate to, the traffic bearing solar panels, and wherein the controller, directs electrical energy to select illumination devices to cause illumination thereof, and/or to the heating element, and/or to an inverter to convert direct current electricity from the plurality of photovoltaic cells to alternating current electricity and/or to convert alternating current electricity to direct current electricity for use, and
a base for mechanically interconnecting each traffic bearing solar panel to the supporting surface for formation of the generally planar, continuous, trafficable surface; and
each traffic bearing solar panel has a multiplicity of predetermined surface sections, and when the traffic bearing solar panel is secured to the supporting surface, each of the multiplicity of predetermined surface sections has a single precise global positioning system (GPS) location; and
the at least one sensor, in communicating with the controller, senses the physical presence of a pedestrian and/or vehicle traveling upon, or adjacent to, the traffic bearing solar panel and the single precise GPS location of the predetermined surface section being traveled upon, and communicates the sensed presence and/or the single precise GPS location to the controller; and
each respective controller, utilizing the single precise GPS location received from the respective sensor, determines a current position, a current direction and a current velocity of the pedestrian and/or vehicular traffic traveling upon the respective predetermined surface section of the traffic bearing solar panel and based upon the determined current position, determined current direction and determined current velocity, and a known prior position, a known prior direction, and a known prior velocity of the pedestrian and/or vehicular traffic traveling upon the traffic bearing solar panels the respective controller determines a predicted future position and/or a predicted future direction and/or a predicted future velocity of the pedestrian and/or vehicular traffic traveling upon the respective predetermined surface section of the traffic bearing solar panel, and the respective controller communicates the predicted future position and/or the predicted future direction and/or the predicted future velocity to controllers of adjacent and other traffic bearing solar panels; and
the respective controllers operatively communicate the determined current position, current direction and/or current velocity and the predicted future position and/or direction and/or velocity of the pedestrians and/or vehicular traffic traveling upon the traffic bearing solar panels to the pedestrian and vehicles traveling upon the solar roadway panels so that the pedestrians and vehicles traveling upon the traffic bearing solar panels receive and may utilize the communicated and received information to control and/or alter control of the pedestrian and/or vehicle traveling upon the intelligent solar roadway system automatically or manually.

2. The intelligent solar roadway system of claim 1 and wherein the sensor is integral with the traffic bearing solar panel.

3. The intelligent solar roadway system of claim 1 and wherein the sensor is remote from the traffic bearing solar panel.

4. The intelligent solar roadway system of claim 1 and wherein the sensor is a pressure sensor that detects changes in weight.

5. The intelligent solar roadway system of claim 4 and wherein the sensor is a piezo-electric device.

6. The intelligent solar roadway system of claim 1 and wherein the sensor is an electromagnetic field (EMF) detector.

7. The intelligent solar roadway system of claim 1 and wherein the sensor is a proximity sensor.

8. The intelligent solar roadway system of claim 1 and wherein the sensor is a photo-optic sensor.

9. The intelligent solar roadway system of claim 1 and wherein the sensor is a temperature sensor.

10. The intelligent solar roadway system of claim 1 and wherein the sensor is a moisture sensor.

11. The intelligent solar roadway system of claim 1 and wherein the sensor is an electromagnetic radiation (EMR) detector.

12. The intelligent solar roadway system of claim 1 and wherein the precise current and precise predicted future GPS locations provided to the vehicle traffic traveling over the intelligent solar roadway system allows the vehicle to operate autonomously using the precise current and precise predicted future GPS locations.

13. The intelligent solar roadway system of claim 1 and wherein the precise current and precise predicted future GPS locations provided to the vehicle traffic traveling over the intelligent solar roadway system is communicated to a smart-phone for use by a user.

14. The intelligent solar roadway system of claim 1 further comprising:
plural sensors integral with each traffic bearing solar roadway panel and plural sensors remote from the traffic bearing solar roadway panel, the plurality of sensors sensing dynamic conditions about the traffic bearing solar panels and communicating the sensed dynamic conditions to the controller.

15. The intelligent solar roadway system of claim 1 further comprising:
an external electric power source operatively communicating with each traffic bearing solar panel to receive electrical energy from the interconnected traffic bearing solar panels and to provide electrical energy to the plurality of interconnected traffic bearing solar panels.
